(19) United States
(12) Patent Application Publication
(10) Pub. No.: US 2013/0135473 A1
(43) Pub. Date: May 30, 2013

(54) METHOD AND SYSTEM FOR VEHICLE SURVEILLANCE

(71) Applicant: QUANTA STORAGE INC., Taoyuan County (TW)

(72) Inventors: Wen-Jing LIN, Taoyuan County (TW); Chia-Szu YU, Taoyuan County (TW)

(73) Assignee: QUANTA STORAGE INC., Taoyuan County (TW)

(21) Appl. No.: 13/661,306

(22) Filed: Oct. 26, 2012

(30) Foreign Application Priority Data
Nov. 29, 2011 (TW) 100143873

(51) Int. Cl. H04N 7/18

(52) U.S. Cl. 348/148; 348/E07.085

(57) ABSTRACT

A method and a system for vehicle surveillance are provided. The vehicle surveillance system integrates a global position system (GPS) and a vehicle recorder. The geographic coordinate of the current parking position is obtained by the GPS system. The vehicle surveillance system is turned off if the vehicle surveillance system is outside a predetermined radius of geographic coordinates of pre-saved non-safe parking positions. The activation of the vehicle surveillance system is maintained such that the vehicle is surveilled and its surrounding images are recorded in a selective and continuous manner if the vehicle surveillance system is within a predetermined radius of the geographic coordinates of non-safe parking positions.

This application claims the benefit of Taiwan application Serial No. 100143873, filed Nov. 29, 2011, the subject matter of which is incorporated herein by reference.

### BACKGROUND OF THE INVENTION

1. Field of the Invention

The invention relates in general to a vehicle surveillance system, and more particularly to a method and a system for vehicle surveillance which incorporates a global positioning system (GPS) signal in determining the activation of the vehicle surveillance system.

2. Description of the Related Art

In a legal society where evidence speaks, the vehicle recorder, which records the on-site images of the spots where traffic disputes arise, is helpful in clarifying the responsibilities of the involved parties and has gradually become an indispensable accessory to the vehicle.

As indicated in FIG. 1, a function block diagram of a vehicle recorder of the prior art is shown. The vehicle recorder 10 of the prior art comprises a lens group 11, a micro-processing unit 12 and a storage unit 13. When the user starts the vehicle, the vehicle power supply 14 is concurrently started to provide a power to the vehicle recorder 10, such that the vehicle recorder 10 can be activated automatically or manually.

During the journey of the vehicle, the signal processing unit 12 of the vehicle recorder 10 controls at least a lens group 11 disposed around the vehicle to shoot the surrounding images. The micro-processing unit 12 further processes and transfers the image signal to the storage unit 13, which saves surrounding images shot during the journey. Therefore, whenever a traffic dispute arises, the user may retrieve the images from the storage unit 13 to restore the on-site situation of the accident.

Although the vehicle recorder 10 may record the surrounding images during the journey of the vehicle, the operation of the vehicle recorder 10 still relies on the power provided by the vehicle power supply 14. To save power consumption and avoid overusing the vehicle power supply 14 or affecting the activation of the vehicle, when the vehicle power supply 14 is turned off, the vehicle recorder 10 is turned off accordingly. As a result, what actually happened during the parking period cannot be known. Therefore, the vehicle recorder of the prior art still has many issues to resolve when it comes to anti-theft and vehicle surveillance.

### SUMMARY OF THE INVENTION

According to an embodiment of the present invention, a vehicle surveillance system is provided. The vehicle surveillance system integrates a GPS system and a vehicle recorder. After the vehicle power supply is turned off, the activation of the vehicle surveillance system is maintained to selectively and continuously surveilled according to a predetermined satellite positioning range saved in the vehicle recorder.

According to another embodiment of the present invention, a vehicle surveillance method is provided. The activation of the vehicle surveillance system is determined according to a predetermined satellite positioning range formed by a GPS geographic coordinate group of non-safe parking positions and a predetermined radius which are pre-saved in a storage unit.

According to an alternate embodiment of the present invention, a method and a system for vehicle surveillance are provided. The vehicle surveillance system is turned off to save power if the vehicle despite being within a satellite positioning range of predetermined non-safe parking positions is at a predetermined safe parking position.

According to another alternate embodiment of the present invention, a method and a system for vehicle surveillance are provided. After the vehicle power supply is turned off, the vehicle surveillance system detects the capacity of the vehicle power supply and timely turns off the vehicle power supply when the capacity is lower than a power-low threshold to avoid affecting the starting of the vehicle.

The vehicle surveillance system of the invention is powered by a vehicle power supply. After the vehicle power supply is turned off, the delay unit delays the termination of the vehicle surveillance system for a predetermined time. The micro-processing unit controls the ON/OFF of the vehicle recorder, records and processes images around the vehicle into audio/video files cyclically saved in a storage unit. The storage unit pre-saves a geographic coordinate group of non-safe parking positions and a predetermined radius. The micro-processing unit controls the GPS system to obtain the geographic coordinate of a parking position. The comparison unit compares the geographic coordinate of the current parking position with a non-safe parking range formed by the geographic coordinate group of non-safe parking positions and a predetermined radius R which are pre-saved in the storage unit to determine whether to maintain the activation of the vehicle surveillance system.

According to the vehicle surveillance system of the invention, the storage unit pre-saves a geographic coordinate group of safe parking position and a predetermined safe radius to form a safe parking range. When the micro-processing unit determines that the vehicle is within a non-safe parking range, the activation of the vehicle surveillance system cannot be maintained unless the safe parking range is exclusive of the current parking position. Also, the micro-processing unit and the vehicle power supply are linked by a power surveillance device, which is controlled by the micro-processing unit to detect the capacity of the vehicle power supply. When the capacity of the vehicle power supply is smaller than a power-low threshold pre-saved in the storage unit, the vehicle surveillance system is turned off.

The vehicle surveillance method of the invention includes the following steps. The vehicle power supply is turned off when the vehicle is parked, and the termination of the vehicle surveillance system is delayed for a predetermined time within which the GPS system obtains the geographic coordinate of the current parking position. Whether the geographic coordinate of the current parking position is within a predetermined radius of a pre-saved geographic coordinate group of non-safe parking positions is determined. If the geographic coordinate of the current parking position is within the predetermined radius of the geographic coordinate group of non-safe parking positions, then the activation of the vehicle surveillance system is maintained. If the geographic coordinate of the current parking position is outside the predetermined radius of the geographic coordinate group of non-safe parking positions, then the vehicle surveillance system is turned off.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a function block diagram of a vehicle recorder according to prior art;

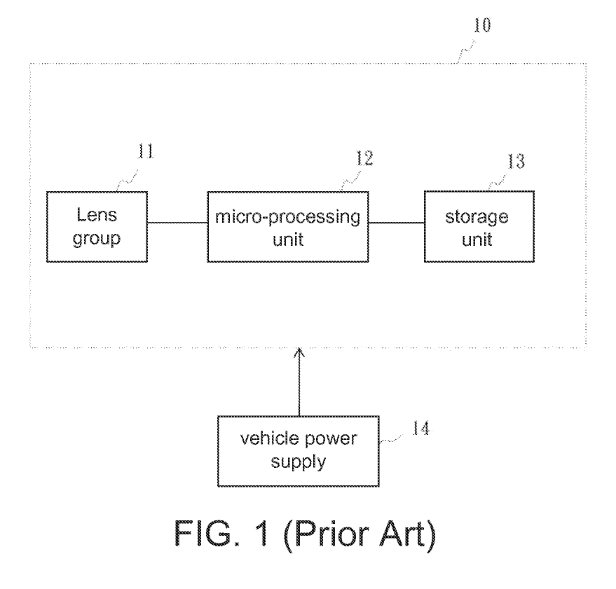

FIG. 2 shows a function block diagram of a vehicle surveillance system according to a first embodiment of the invention;

FIG. 3 shows a schematic diagram of a vehicle parking surveillance range according to a first embodiment of the invention;

FIG. 4 shows a flowchart of a method for vehicle surveillance according to a first embodiment of the invention;

FIG. 5 shows a schematic diagram of a vehicle parking surveillance range according to a second embodiment of the invention;

FIG. 6 shows a flowchart of a method for vehicle surveillance system according to a second embodiment of the invention;

FIG. 7 shows a function block diagram of a vehicle surveillance system according to a third embodiment of the invention; and

FIG. 8 shows a flowchart of a method for vehicle surveillance system according to a third embodiment of the invention.

### DETAILED DESCRIPTION OF THE INVENTION

The technologies used to achieve the above objects of the invention and the effects of the technologies are elaborated below in a number of exemplary embodiments with reference to accompany drawings.

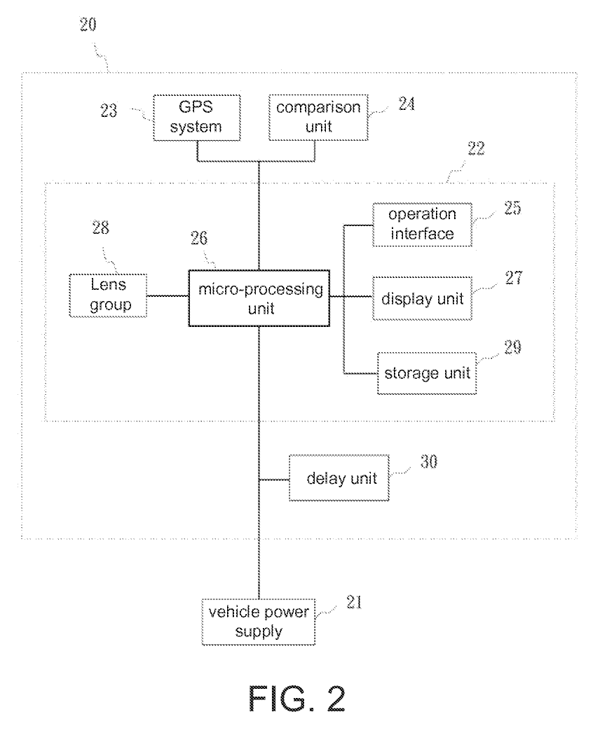

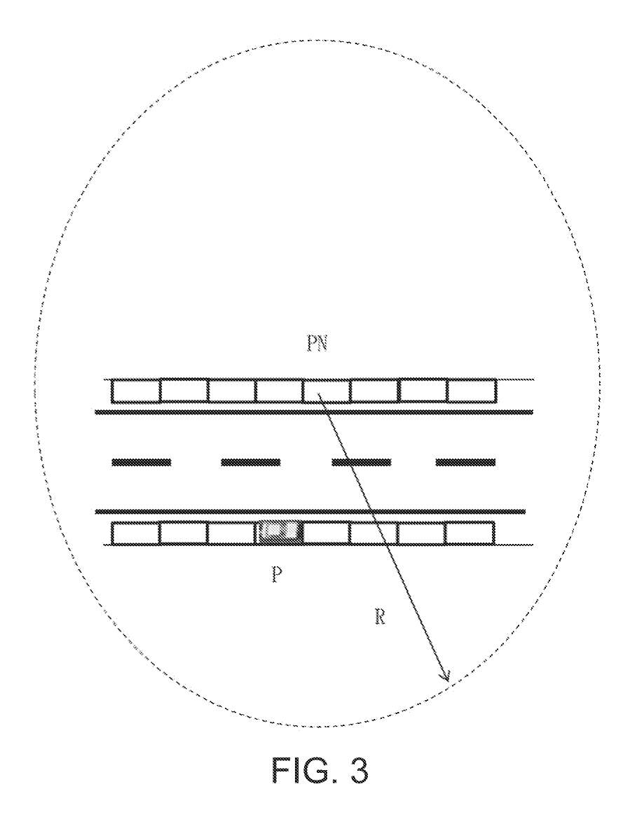

Referring to FIG. 2 and FIG. 3. FIG. 2 shows a function block diagram of a vehicle surveillance system 20 according to a first embodiment of the invention. FIG. 3 shows a schematic diagram of a vehicle parking surveillance range according to a first embodiment of the invention. The vehicle surveillance system 20 is powered by a vehicle power supply 21, and comprises a vehicle recorder 22, a global position system (GPS) 23, a comparison unit 24 and a delay unit 30. The vehicle recorder 22 comprises an operation interface 25, a micro-processing unit 26, a display unit 27, a lens group 28 and a storage unit 29. The vehicle recorder 22 inputs a control command via the operation interface 25. The micro-processing unit 26 controls the ON/OFF of the vehicle recorder 22. The micro-processing unit 26 further controls the display unit 27 and sets the lens group 28 to a shooting mode. The lens group 28 comprises at least a lens disposed around the vehicle for shooting surrounding images. The micro-processing unit 26 receives audio/video signals from the lens group 28 and then processes the audio/video signals into audio/video files cyclically saved in the storage unit 29. To check the audio/video files saved in the storage unit 29, the vehicle recorder 22 selects the audio/video files shown on the display unit 27 and saved in the storage unit 29 via the operation interface 25, and then instructs the micro-processing unit 26 to transfer the selected audio/video files to the display unit 27 which accordingly plays the selected files. Thus, the vehicle recorder 22 achieves the objects of recording and surveilling images around the vehicle.

The GPS system 23 is linked to the vehicle recorder 22, and is turned on/off by the micro-processing unit 26 to obtain a geographic coordinate P of the vehicle, display the geographic coordinate P on the display unit 27, and then transfer the geographic coordinate P to the comparison unit 24 or save the geographic coordinate P in the storage unit 29. The storage unit 29 additionally pre-saves a predetermined geographic coordinate group of non-safe parking positions PN and a predetermined radius R. Examples of the predetermined geographic coordinate group of non-safe parking positions PN include the road sides where vehicles are susceptible to crashing and the hot points of automobile theft. The driver may input and display the geographic coordinates of non-safe parking positions on the display unit 27 via the operation interface 25, and then instruct the micro-processing unit 26 to save the geographic coordinates in the storage unit 29. Alternatively, the micro-processing unit 26 may download the geographic coordinates of hot points of automobile theft or accident from the cloud database of automobile service providers or police statistics and then save the downloaded data in the storage unit 29.

The comparison unit 24 is linked to the vehicle recorder 22. The comparison unit 24 is controlled by the micro-processing unit 26 to compare the geographic coordinate P of the parking position obtained by the GPS system with a non-safe parking range formed by a geographic coordinate group of non-safe parking positions PN and a predetermined radius R thereof that are pre-saved in the storage unit 29. The comparison is used as a basis for determining the activation of the vehicle surveillance system 20. The delay unit 30 is linked to the vehicle recorder 22, and is controlled by the micro-processing unit 26 for whether to delay the termination of the vehicle surveillance system 20 for a predetermined time after the vehicle power supply 21 is turned off.

When the vehicle is activated, the vehicle power supply 21 provides a power to the vehicle surveillance system 20, and the micro-processing unit 26 automatically activates the vehicle recorder 22 and the GPS system 23. The vehicle recorder 22 shoots and records images during the journey of the vehicle. The GPS system 23 provides the geographic coordinate P of the vehicle. The micro-processing unit 26 receives and processes the geographic coordinate P of the vehicle provided by the GPS system 23. The driver inputs a control command via the operation interface 25, and uses the micro-processing unit 26 to select whether to use the GPS system 23 or to view the images shot or recorded by the vehicle recorder 22 on the display unit 27.

After the vehicle is parked and the vehicle power supply 21 is turned off, the delay unit 30 delays the termination of the power of the vehicle surveillance system 20 for a predetermined time, and the micro-processing unit 26 transfers the geographic coordinate of the current parking position P obtained by GPS system 23 and the geographic coordinate group of non-safe parking positions PN pre-saved in the storage unit 29 to the comparison unit 24 for comparison. If the geographic coordinate of the current parking position P is within a predetermined radius R of the geographic coordinate group of non-safe parking positions PN, then the micro-processing unit 26 determines that the parking position as a non-safe position, suspends the delay unit 30 and automatically maintains the activation of the vehicle surveillance system 20, such that the vehicle recorder 22 continues to surveille and record images around the vehicle during the parking period. During the period when the vehicle surveillance system 20 is automatically activated, the driver may decide whether to manually turn off the vehicle surveillance system 20 via the operation interface 25.

When the geographic coordinate of the current parking position P is outside the predetermined radius R of the geographic coordinate group of non-safe parking positions PN, the micro-processing unit 26 determines the parking position as a safe position, and automatically turns off the vehicle surveillance system 20 after a predetermined time. After the vehicle surveillance system 20 is turned off, the driver may also select whether to manually activate the vehicle surveillance system 20 according to the safety of the parking position. If the vehicle surveillance system 20 is manually activated, then the micro-processing unit 26 determines the parking position as a non-safe parking position. Then, the GPS system 23 obtains the geographic coordinate of the current parking position P and further saves the obtained geographic coordinate to the storage unit 29 to form a predetermined geographic coordinate group of non-safe parking positions PN, and the vehicle surveillance system 20 continues to perform surveillance.

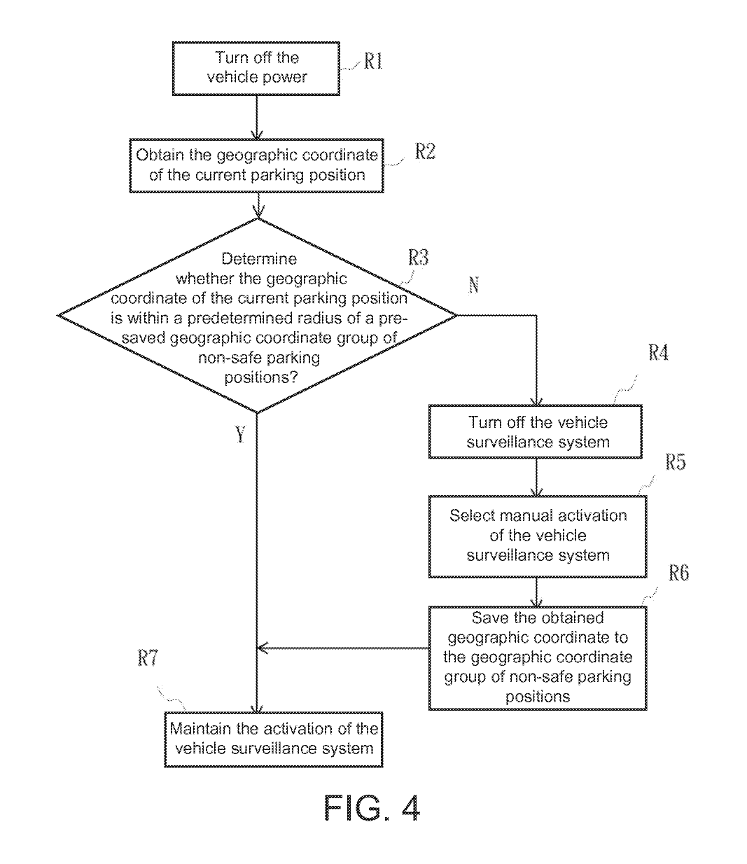

As indicated in FIG. 4, a flowchart of a method for vehicle surveillance according to a first embodiment of the invention is shown. Detailed procedures of the method for using the GPS system to determine the activation of the vehicle surveillance system are as follows: In step R1, the vehicle is parked and the vehicle power supply is turned off. In step R2, the termination of the vehicle surveillance system is delayed for a predetermined time and the geographic coordinate of the current parking position is obtained by the GPS system. In step R3, whether the geographic coordinate of the current parking position is within a predetermined radius of a pre-saved geographic coordinate group of non-safe parking positions is determined. If the geographic coordinate of the current parking position is outside the predetermined radius of the geographic coordinate group of non-safe parking positions, then the method proceeds to step R4. If the geographic coordinate of the current parking position is within the predetermined radius of the geographic coordinate group of non-safe parking positions, then the method proceeds to step R7. In step R4, the current parking position is determined as a safe parking position, and the vehicle surveillance system is turned off. In step R5, manual activation of the vehicle surveillance system is selected. In step R6, the geographic coordinate of the current parking position is obtained and saved to the geographic coordinate group of non-safe parking positions by the GPS system. In step R7, the current parking position is determined as a non-safe parking position, and the activation of the vehicle surveillance system is automatically maintained.

To summarize, the method and the system for vehicle surveillance of the first embodiment of the invention integrate a GPS system and a vehicle recorder. A satellite positioning range of predetermined non-safe parking positions is formed by a GPS geographic coordinate group of non-safe parking positions and a predetermined radius which are pre-saved in a storage unit. After the vehicle is parked, the geographic coordinate is detected and compared with the satellite positioning range of non-safe parking positions, and the vehicle surveillance system is automatically activated, such that the vehicle is selectively and continuously surveilled.

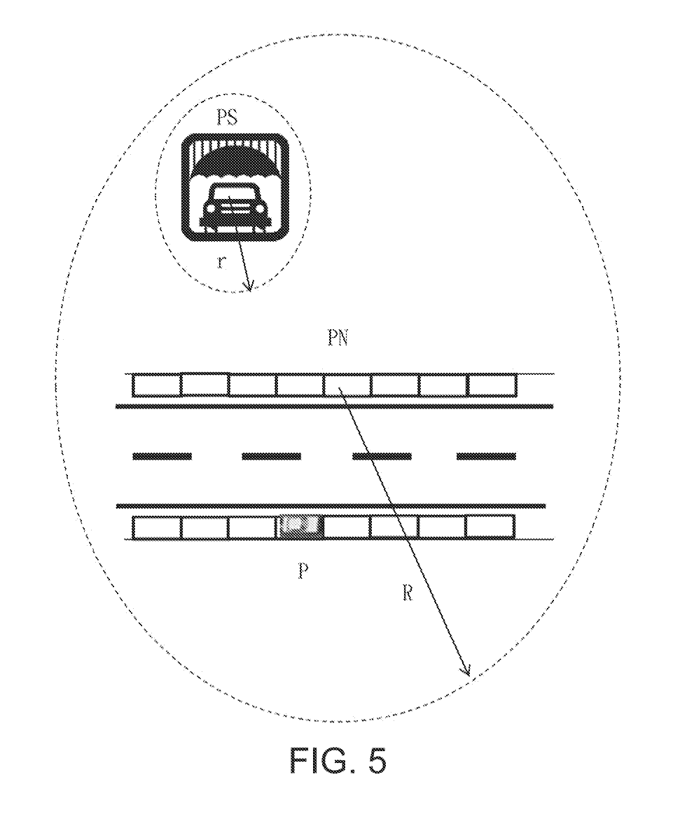

As indicated in FIG. 5, a schematic diagram of a vehicle parking surveillance range according to a second embodiment of the invention is shown. The structure of the vehicle surveillance system of the second embodiment of the invention is identical to that of the vehicle surveillance system of the first embodiment of the invention. As the vehicle surveillance system of the first embodiment is relatively safe when the vehicle is parked at home or at a parking area with security guard, there is no need to activate the vehicle surveillance system after the vehicle is parked at a safe parking position. However, once the vehicle leaves the safe parking position, the surrounding environment may not be safe any more. If the safe parking position is within the predetermined radius R of the geographic coordinate group of non-safe parking positions PN disclosed above, the vehicle surveillance system of the first embodiment of the invention will be automatically activated, not only wasting the power of the vehicle power supply, but also requiring manual termination of the vehicle surveillance system. This is indeed very inconvenient. Therefore, the vehicle surveillance system of the second embodiment of the invention pre-saves a predetermined geographic coordinate group of safe parking positions PS and a predetermined safe radius r in the storage unit to form a safe parking range. The predetermined safe radius r is smaller than the predetermined radius R, and mainly covers a small range of safe parking positions. When the vehicle surveillance system of the second embodiment of the invention determines that the vehicle is within the predetermined radius R of the geographic coordinate group of non-safe parking positions PN, the activation of the vehicle surveillance system cannot be maintained unless the safe parking range formed by the geographic coordinate group of safe parking position PS and the predetermined safe radius r are exclusive of the current parking position.

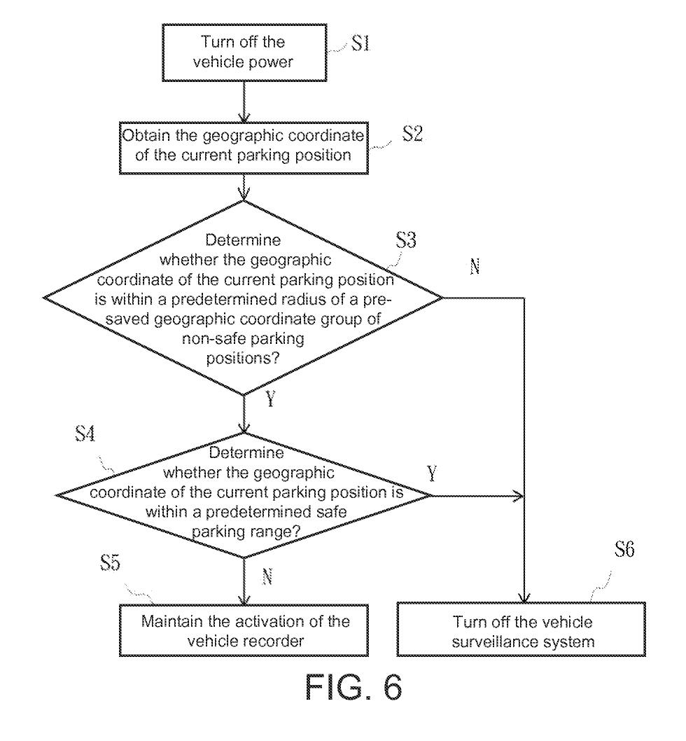

As indicated in FIG. 6, a flowchart of a method for vehicle surveillance system according to a second embodiment of the invention is shown. Detailed procedures of the method for vehicle surveillance according to a second embodiment of the invention are as follows: In step S1, the vehicle is parked and the vehicle power supply is turned off. In step S2, the termination of the vehicle surveillance system is delayed for a predetermined time and the geographic coordinate of the current parking position is obtained by the GPS system. In step S3, whether the geographic coordinate of the current parking position is within a predetermined radius of a pre-saved geographic coordinate group of non-safe parking positions is determined. If the geographic coordinate of the current parking position is within the predetermined radius of the geographic coordinate group of non-safe parking positions, then the method proceeds to step S4. If the geographic coordinate of the current parking position is outside the predetermined radius of the geographic coordinate group of non-safe parking positions, then the method proceeds to step S6. In step S4, whether the geographic coordinate of the current parking position is within a predetermined safe radius of a pre-saved geographic coordinate group of safe parking positions is determined. If the geographic coordinate of the current parking position is outside the predetermined safe radius of the geographic coordinate group of safe parking positions, then the method proceeds to step S5. If the geographic coordinate of the current parking position is within the predetermined safe radius of the geographic coordinate group of safe parking positions, then the method proceeds to step S6. In step S5, the current parking position is determined as a non-safe parking position, and the activation of the vehicle recorder is automatically maintained. In step S6, the current parking position is determined as a safe parking position, and the vehicle surveillance system is turned off.

According to the method and a system for vehicle surveillance disclosed in the second embodiment of the invention, when the vehicle is parked within a predetermined satellite positioning range of non-safe parking positions, the vehicle surveillance system is automatically turned off if the vehicle is within a predetermined safe radius of a geographic coordinate group of pre-saved safe parking positions. The operation of the vehicle surveillance system is made easier and more power-saving.

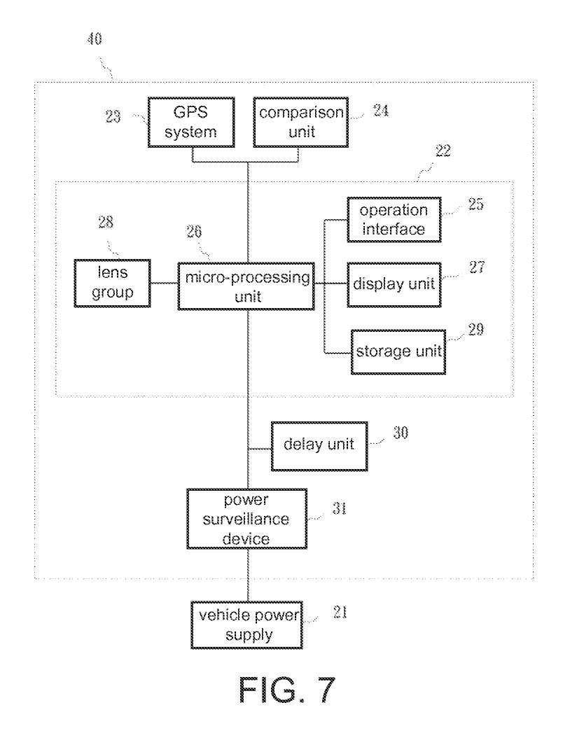

Referring to FIG. 7, a function block diagram of a vehicle surveillance system 40 according to a third embodiment of the invention is shown. The structure and functions of the vehicle surveillance system 40 of the third embodiment are similar to that of the vehicle surveillance system 20 of the first embodiment except that the vehicle surveillance system 40 further comprises a power surveillance device 31. For convenience of elaboration, components common to the vehicle surveillance system 20 of the first embodiment retain the same numeric designations. The power surveillance device 31 is linked between the micro-processing unit 26 and the vehicle power supply 21, and is controlled by the micro-processing unit 26 to detect the capacity of the vehicle power supply 21. The capacity of the vehicle power supply 21 is used as a basis for determining whether to activate or to turn off the vehicle surveillance system 40. During period when the vehicle surveillance system 40 is activated, the micro-processing unit 26 controls the power surveillance device 31 to detect the capacity of the vehicle power supply 21. A predetermined power-low threshold is saved in the storage unit 29. The power detected by the power surveillance device 31 is compared with the power-low threshold. If the detected power is smaller than the power-low threshold, then the vehicle surveillance system 40 is turned off lest the vehicle power supply 50 might be overused so as to affect the activation of the vehicle.

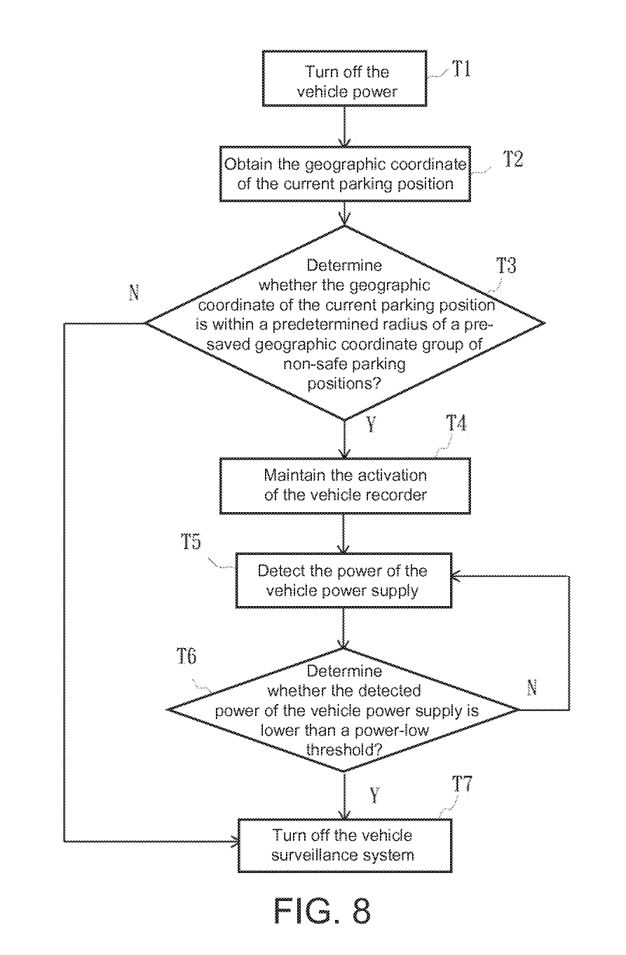

As indicated in FIG. 8, a flowchart of a method for vehicle surveillance system according to a third embodiment of the invention is shown. Details of the procedures of the method for the vehicle surveillance system of the third embodiment of the invention are disclosed below. In step T1, the vehicle is parked and the vehicle power supply is turned off. In step T2, the termination of the vehicle surveillance system is delayed for a predetermined time and the geographic coordinate of the current parking position is obtained by the GPS system. In step T3, whether the geographic coordinate of the current parking position is within a predetermined radius of a pre-saved geographic coordinate group of non-safe parking positions is determined. If the geographic coordinate of the current parking position is within the predetermined radius of the geographic coordinate group of non-safe parking positions, then the method proceeds to step T4. If the geographic coordinate of the current parking position is outside the predetermined radius of the geographic coordinate group of non-safe parking positions, then the method proceeds to step T7. In step T4, the current parking position is determined as a non-safe parking position, and the activation of the vehicle recorder is automatically maintained. In step T5, the capacity of the vehicle power supply is detected. In step T6, whether the detected capacity of the vehicle power supply is lower than a power-low threshold is determined. If the detected power is not lower than a power-low threshold, then the method returns to step T5 and the capacity of the vehicle power supply is continuously detected. If the detected power is lower than the power-low threshold, then the method returns to step T7. In step T7, the vehicle surveillance system is turned off.

According to the method and a system for vehicle surveillance disclosed in the third embodiment of the invention, after the vehicle power supply is turned off, and the activation of the vehicle surveillance system is maintained if the current parking position is determined as a non-safe parking position, and whether the capacity of the vehicle power supply is lower than a power-low threshold is further determined. If the capacity is lower than the power-low threshold, the vehicle power supply is turned off lest the activation of the vehicle might be affected.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A vehicle surveillance system, wherein the vehicle surveillance system is powered by a vehicle power supply and comprises:
a vehicle recorder whose ON/OFF is controlled by a micro-processing unit, wherein the vehicle recorder records and processes images around the vehicle into audio/video files cyclically saved in a storage unit, which pre-saves a geographic coordinate group of non-safe parking positions and a predetermined radius;
a global position system (GPS) linked to the vehicle recorder, wherein the GPS system is controlled by the micro-processing unit to obtain the geographic coordinate of a parking position;
a comparison unit linked to the vehicle recorder, wherein the comparison unit is controlled by the micro-processing unit to compare the geographic coordinate of the current parking position with a non-safe parking range formed by the geographic coordinate group of non-safe parking positions and a predetermined radius R which are pre-saved in the storage unit; and
a delay unit linked to the vehicle recorder, wherein the delay unit is controlled by the micro-processing unit to delay a termination of the vehicle surveillance system for a predetermined time after the vehicle power supply is turned off;
wherein, after the vehicle power supply is turned off, the micro-processing unit controls the delay unit to delay the termination of the vehicle surveillance system, controls the GPS system to obtain the geographic coordinate of the current parking position, and controls the comparison unit to compare the obtained geographic coordinate with the non-safe parking range saved in the storage unit to determine whether to maintain the activation of the vehicle surveillance system.

2. The vehicle surveillance system according to claim 1, wherein when the vehicle surveillance system is manually activated, the micro-processing unit determines the parking position as a non-safe parking position, the GPS system obtains the geographic coordinate of the current parking position, and the storage unit saves the geographic coordinate of the current parking position to the geographic coordinate group of non-safe parking positions.

3. The vehicle surveillance system according to claim 1, wherein the storage unit pre-saves the geographic coordinate group of safe parking position and a predetermined safe radius to form a safe parking range.

4. The vehicle surveillance system according to claim 3, wherein when the micro-processing unit determines that the vehicle is within the non-safe parking range, the activation of the vehicle surveillance system cannot be maintained unless the safe parking range is exclusive of the current parking position.

5. The vehicle surveillance system according to claim 1, wherein the micro-processing unit and the vehicle power supply are linked by a power surveillance device, which is controlled by the micro-processing unit to detect the capacity of the vehicle power supply.

6. The vehicle surveillance system according to claim 5, wherein the storage unit pre-saves a power-low threshold, and when the power surveillance device detects that the capacity of the vehicle power supply is smaller than the power-low threshold, the vehicle surveillance system is turned off.

7. A vehicle surveillance method, comprising:
(1) turning off the vehicle power supply when the vehicle is parked, and delaying the termination of the vehicle surveillance system for a predetermined time within which the GPS system obtains the geographic coordinate of the current parking position;
(2) determining whether the geographic coordinate of the current parking position is within a predetermined radius of a pre-saved geographic coordinate group of non-safe parking positions, and the method proceeds to step (3) if the geographic coordinate of the current parking position is within the predetermined radius of the geographic coordinate group of non-safe parking positions, and proceeds to step (4) if the geographic coordinate of the current parking position is outside the predetermined radius of the geographic coordinate group of non-safe parking positions;
(3) maintaining the activation of the vehicle surveillance system;
(4) turning off the vehicle surveillance system.

8. The vehicle surveillance method according to claim 7, wherein after it is determined that the geographic coordinate of the current parking position is outside the predetermined radius of the geographic coordinates of non-safe parking positions, whether the geographic coordinate of the current parking position is within the predetermined safe radius of the geographic coordinate group of pre-saved safe parking positions is determined, and the method proceeds to step (4) if the geographic coordinate of the current parking position is outside the predetermined safe radius of the geographic coordinate group of safe parking positions and proceeds to step (3) if the geographic coordinate of the current parking position is within the predetermined safe radius of the geographic coordinate group of safe parking positions.

9. The vehicle surveillance method according to claim 7, wherein after the activation of the vehicle surveillance system is maintained, the capacity of the vehicle power supply is detected, and whether the capacity of the vehicle power supply is lower than a predetermined power-low threshold is determined, and the capacity of the vehicle power supply is continuously detected if the capacity of the vehicle power supply is lower than the predetermined power-low threshold and the vehicle surveillance system is turned off if the capacity is lower than the predetermined power-low threshold.

10. The vehicle surveillance method according to claim 9, wherein after the vehicle surveillance system is turned off, manual activation of the vehicle surveillance system is selected.

11. The vehicle surveillance method according to claim 10, wherein the GPS system obtains the geographic coordinate of the current parking position which is saved to the geographic coordinate group of non-safe parking positions.
